(19) United States
(12) Patent Application Publication
(10) Pub. No.: US 2006/0257841 A1
(43) Pub. Date: Nov. 16, 2006

(54) Automatic paper grading and student progress tracking system

(76) Inventor: Angela Mangano, West Palm Beach, FL (US)

Correspondence Address: Angela Mangano, 7730 Woodsmuir Drive, West Palm Beach, FL, 33412, US

(21) Appl. No.: 11/129,973

(22) Filed: May 16, 2005

(51) Int. Cl. G09B 3/00

(52) U.S. Cl. 434/354

(57) ABSTRACT

An automatic paper grading system comprises a main grader unit and a detachable portable teacher unit which can be coupled to the grader unit for bidirectional data transmission. The teacher unit includes a CPU, memory, data input means, a display, and a data port. The CPU means is operable to accept entry of a Scoring Key using the alphanumeric input means. The Scoring Key can be transmitted from the portable teacher unit to the grader unit. The grader unit includes a processor, a memory, a printer, a scanner unit having OCR capability, a data port, and a sheet-feeding means to receive a sheet of paper and automatically guide the sheet of paper through the grader unit and the printer means. An algorithm resident in the grader unit determines incorrect answers and scores the paper based on a Scoring Key: A print command can be sent to the printer to print indicia on the paper to indicate incorrect answers.

### FIELD OF THE INVENTION

The present invention relates to an automatic paper grading system having an optical scanner and printer unit which engages with a portable teacher unit, and more particularly to an automatic grading machine which is integrated into a student progress tracking system.

### BACKGROUND OF THE INVENTION

Teaching basic skills such as reading and writing in elementary school is most effectively accomplished by constant repetition, with the students completing class work and homework assignments by hand on a daily basis. This creates a tremendous workload for the teacher, who must not only grade the papers but also maintain a record of all student grades. During the course of a school year, class grades records can be maintained by a teacher in a notebook in a spreadsheet type format. In some cases, students may receive grades using different grading criteria depending on the nature of the assignment, such as percentages (0-100%), letter grades (A-F), satisfactory/unsatisfactory indicators, rubric scores, etc. In order to compute an average grade for a given period, the teacher convert all grades from dissimilar grading systems to a single numeric system.

It has been recognized that the test grading aspect of the teacher's workload can be automated. The use of automatic test scoring machines is known in the art, with the most commonly known being that which uses a test booklet with a separate tabulated scoring sheet. The scoring sheet is usually marked with special writing implements, e.g. No. 2 lead pencils, and can graded by optical or magnetic scanning.

This type of scoring system necessitates rigid formats for test questions, with the most common format being multiple choice. To provide greater flexibility for designing educational tests and the like, more recent prior art devices use an optical scanner in combination with image recognition software which can read and compare handwritten indicia. George-Morgan, U.S. Pat. No. 6,112,050, discloses an automatic grader device which includes an optical scanner and a printer, and is hereby incorporated herein by reference. An initial answer key sheet is having answers in the form of alphanumeric characters is fed through the scanner and stored electronically. An error detection mechanism which includes optical character recognition ability compares characters of each of the student answer sheets with those of the answer key sheet. The device deducts from a total score a worth of each error times a number of errors on each student answer sheet, prints an “X” on the copy adjacent each error detected, and prints a net score on the copy of the student answer sheet.

While the George-Morgan device is effective to grade the papers by scanning and printing the results thereon, it does not retain the score data in a memory, or otherwise track and compile score data for a student over a period of time. In order to provide an integrated system to automatically score papers and track student progress, it would be highly desirable to provide a scoring device which would not only score the papers, but which would store pupil test score data for any number of pupils in non-volatile memory for future manipulation and analysis.

The present invention provides an improvement over prior art devices by providing an automated paper grading system which stores student data in a memory, and which preferably stores the grade data in a separate, portable electronic device which functions as an all purpose record keeping and planning device for the teacher to replace the traditional physical grade book.

### SUMMARY OF THE INVENTION

Accordingly, it is an objective of the instant invention to provide an automatic school paper grading system having a main unit which includes an optical scanner, OCR software, and a printer.

It is a further objective of the instant invention to provide an automatic school paper grading system which includes a detachable portable teacher unit similar to a Personal Data Assistant (PDA) which can be coupled to the main unit for to allow bidirectional data transmission therebetween.

It is yet another objective of the instant invention to provide an automatic school paper grading system which stores grade data in a database resident in the portable teacher unit.

It is a further objective of the instant invention to provide an automatic school paper grading system which includes a detachable portable teacher unit which can interface with a personal computer or other electronic device.

It is a further objective of the present invention to provide an automatic school paper grading system which includes spell check and grammar check software.

It is a still further objective of the invention to provide an automatic school paper grading system which averages grades over a given period, and which allows a teacher to use different grading scales depending on the nature of the assignment, and further allows the teacher to assign percentage weights to each assignment.

In accordance with the above objectives, an automatic school paper grading and student progress tracking system comprises a main grader unit and a at least one detachable portable teacher unit, similar to a PDA, which can be coupled to the grader unit for bidirectional data transmission. The grader unit includes a processing means, a memory means, a printer means, a scanner unit having Optical Character Recognition (OCR) means wherein the scanner unit is operable to optically recognize indicia on a sheet of paper, a data I/O port, and a sheet-feeding means configured to receive the sheet of paper and automatically guide the sheet of paper through the grader unit and the printer means. The memory means having a software algorithm resident thereon which is operable to perform the following steps: recognizing indicia on the sheet of paper representing test answers; comparing the indicia to a Scoring Key to determine correct and incorrect answers; sending a print command to the printer to print indicia on the paper to indicate incorrect answers; determining the number of incorrect answers; calculating a Score based on the the number of incorrect answers; storing the Score in a database; and sending a print command to the printer to print indicia on the paper to indicate the Score.

The portable teacher unit includes a CPU, a memory means, an alphanumeric data input means, a LCD display, and at least one data I/O port. The data input means can be an alphanumeric keypad or a touchscreen. The processing means is operable to accept entry of a Scoring Key into the memory using the alphanumeric input means. A means is provided for coupling the portable teacher unit to the grader unit whereby the Scoring Key can be transmitted from the portable teacher unit to the grader unit.

The grader unit has a housing can be configured to provide a docking station port therein containing the data I/O port of the grader unit, with the portable teacher unit having a housing configured for complementary mated engagement with the docking station to allow the alignment and engagement of the respective data I/O ports

The database can resides in the memory means of the portable teacher unit. The memory means in the portable teacher unit further can includes a spreadsheet algorithm which allows thee database to be manipulated to generate a desired spreadsheet. The spreadsheet can be downloaded to the grader unit in order for the grader unit to print the spreadsheet in ASCII format. The portable teacher unit further comprises a data I/O port which can be coupled to a personal electronic device, such as a personal computer, for bidirectional data transmission.

Other objects and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a schematic representation of a school paper grading and a progress tracking system according to a preferred embodiment;

FIG. 2 is a perspective view of the grader unit having the portable teacher unit seated in a docking station;

FIG. 3 is a perspective view of the grader unit showing the portable teacher unit detached from the docking station;

FIG. 4 is a front view of an exemplary portable teacher unit according to a preferred embodiment;

FIG. 5 is a printed version of a typical Scoring Key template;

FIG. 6 illustrates the steps for entering the scoring key into the teacher unit;

FIG. 7 illustrates the steps for scoring the student documents using the grader unit; and

FIG. 8 illustrates an example of a test paper sheet which has been scored by the grader unit.

### DETAILED DESCRIPTION OF THE INVENTION

Although the invention will be described in terms of a specific embodiment, it will be readily apparent to those skilled in this art that various modifications, rearrangements, and substitutions can be made without departing from the spirit of the invention. The scope of the invention is defined by the claims appended hereto.

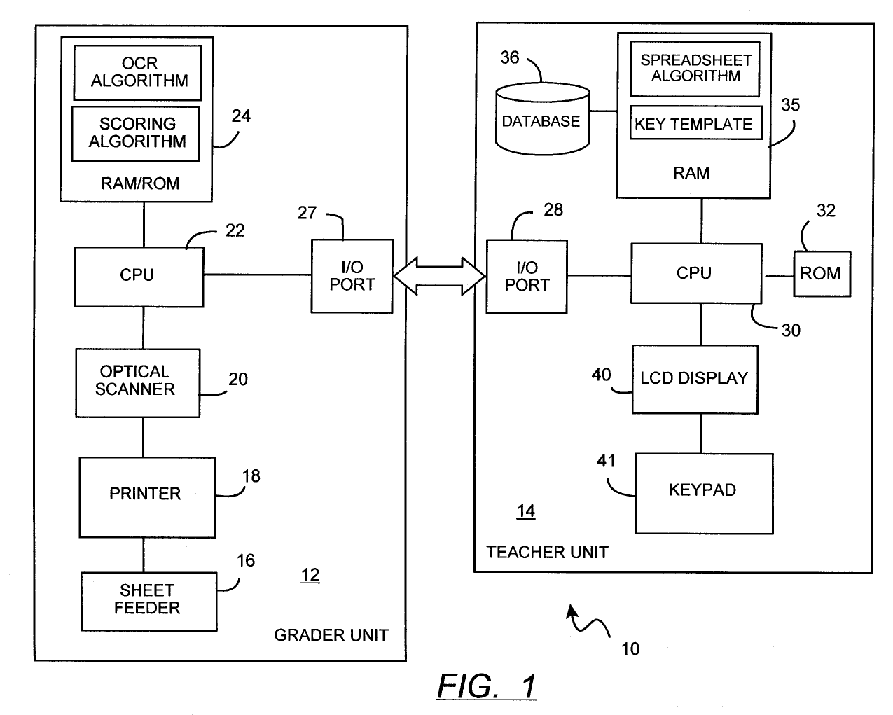

FIG. 1 schematically illustrates the components of a school paper grading and a progress tracking system 10 according to a preferred environment of the invention. The system 10 includes a grader unit 12 and at least one teacher unit 14, which are constructed as discretely separate components. The teacher unit 14 is a portable, hand-held unit which can be selectively attached and detached from the grader unit 12. In use, the system may include a plurality of portable teacher units 14 which are used with a central grader unit 12. The grader unit 12 and teacher unit 14 each respectively include I/O data ports 27, 28 which can be coupled to one another to allow bidirectional data transmission therebetween. The method of data transmission can be any suitable means known in the art, including infrared and RF transmissions. The grader unit 12 includes a standard sheet feeder 16, a printer 18 and an optical scanner 20, as well as an processor 22 which is coupled to memory 24. In the preferred embodiment, the grader unit 12 has a configuration similar to that of a standard copier or fax machine and includes an imaging region for optically scanning sheets of paper. The sheet feeder 16 can be any of the type well known in the art which includes a suitable mechanism for transporting sheets of paper through the device. The sheet feeder 16 is preferably constructed to receive a plurality of sheets of paper (in a stacked arrangement) and automatically guide the sheets of paper one at a time first through the imaging region for recognition by the optical scanner, and then through the printer 18. The operative mechanisms of the printer 18 can be of any type known in the art, including ink jet, laser, thermal, dot matrix, etc.

Resident in the memory 24 of the grader unit 12 is optical character recognition (OCR) software which is operable to recognize indicia on the sheets from the optically scanned image. In the practice of the invention, it is preferred that the OCR program have the capability to recognize handwritten indicia. Systems for optical recognition of handwriting are well known in the art, and the operation of such systems is therefore not addressed herein in detail.

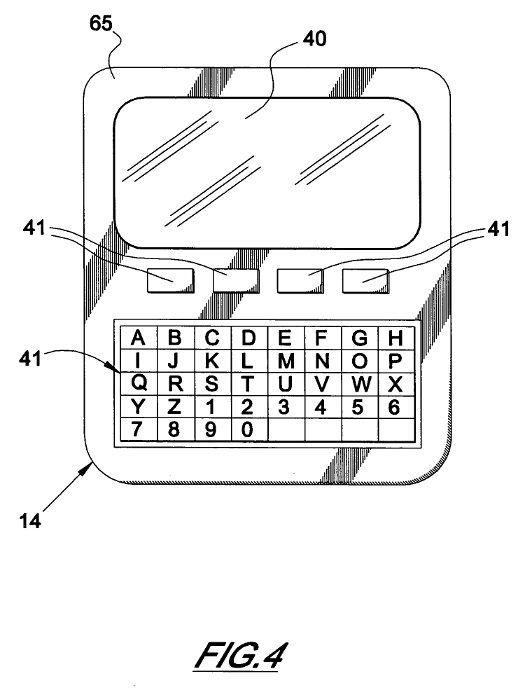

The teacher unit 14 is a personal digital assistant (PDA) device, and can be, for example, any of the PDAs manufactured by Palm, Casio, Compaq, Handspring, HP, Microsoft, or Sony. The teacher unit 14 of the invention can also be a PDA of a proprietary design. A front view of an exemplary design for a portable teacher unit 14 is shown in FIG. 4. The teacher unit 14 includes a display means, such as LCD display 40, and a means to input alphanumeric data, such as keypad 41. Referring again to the schematic view shown in FIG. 1, the teacher unit 14 also includes a CPU 30, ROM 32, which includes software programs 29, and RAM 35, which includes database 36. The CPU can be any suitable microprocessor, such as the Motorola Dragonball, Multiprocessor without Interlocked Pipeline Stages (MIPS), or the Hitachi SH7709a. The LCD display can also be configured as a touchscreen for data input using a stylus. In addition to the inventive software 29 installed on ROM 32, the software 29 can include programs to implement communication functions such as receipt and transmission of email and the ability to access electronic networks such as the Internet. When the grader unit 12 and the teacher unit 14 are in communication, the grader unit 12 also advantageously operates as a standard printer for the teacher unit 14.

The I/O data port 27 in the grader unit 12 can be an electrical port which establishes an electrical connection with complementary port 28 in the teacher unit 14. The data port 27 can be configured to a particular commercially available PDA, such as the Palm Pilot, and would therefore comprise a connector that mates with the connector provided by the PDA, such as a serial or USB port. The data port 27 can also provide a universal interface or a standard interface having adapters for various brands of PDAs. The data transmission means between the grader unit 12 and teacher unit 14 can also be through infrared ports or RF antennas.

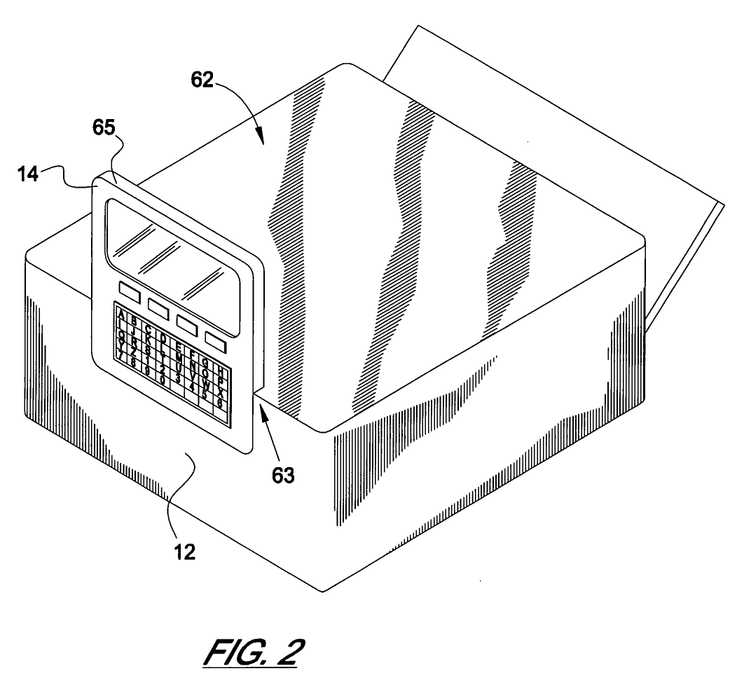

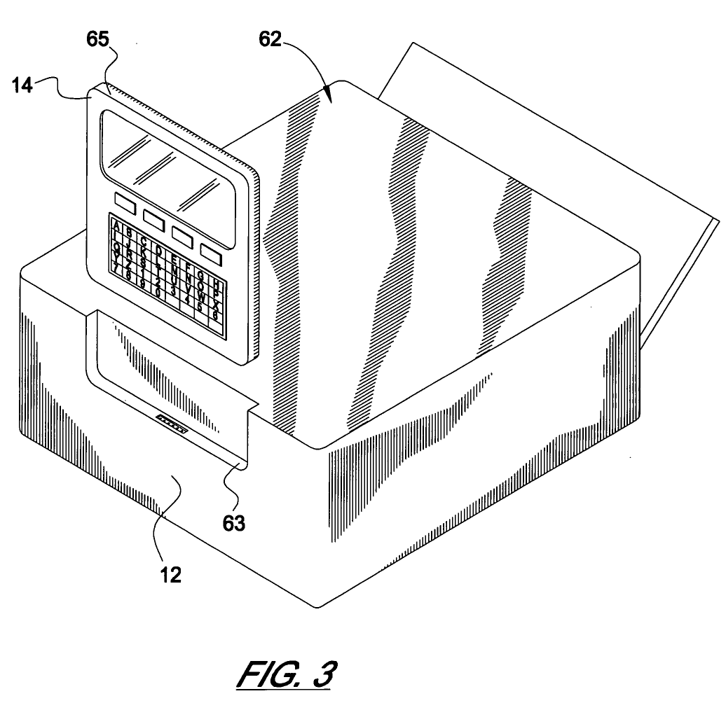

In a preferred embodiment shown in the pictorial illustrations in FIGS. 2 and 3, the grader unit 12 can have a housing 62 configured to provide a docking station 63 having the I/O data port 27 positioned therein. The portable teacher unit 14 has a housing 65 which is configured for complimentary mated engagement with the docking station 63 so that the I/O data ports 27 and 28 are aligned when the portable teacher unit 14 is inserted therein and engaged to allow bidirectional data transmission.

The docking station 63 is also preferably configured to accept and secure at least a portion of the portable teacher unit 14 so that the unit 14 may be operated while docked to the docking station 63. The teacher unit 14 can be retained in such a manner that at least the display and data entry features, such as a touch screen and/or keyboard, are readily accessible by a user.

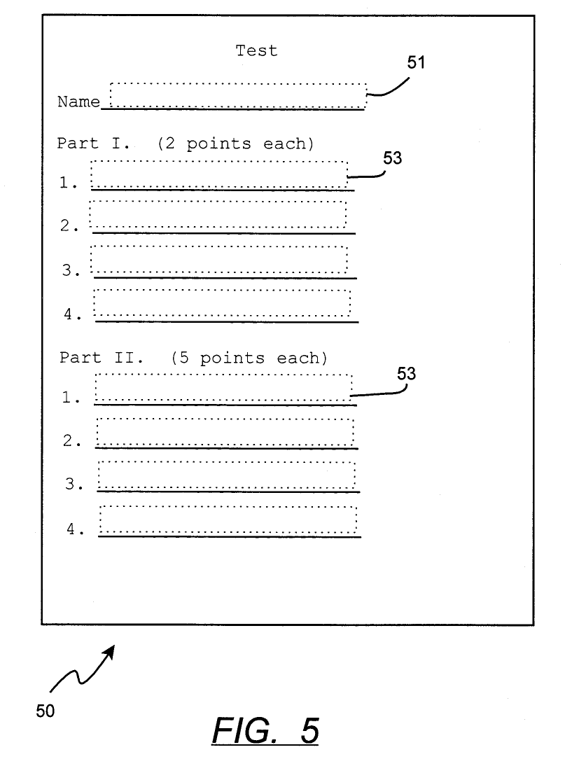

In use, a Scoring Key is entered into the portable teacher unit 14 or downloaded from an external source. At the time the papers are to be graded, the portable teacher unit 14 is coupled to the grader unit 12 for data transmission therebetween so that the Scoring Key can be accessed by the processor 22. The Scoring Key can be entered in the portable teacher unit 14 in alphanumeric format using the keypad 41. In the preferred embodiment, the Scoring Key is entered into predefined templates which can be selected using the portable teacher unit 14. FIG. 5 illustrates an example of a typical template, shown in printed page format for ease of description. This template is exemplary only, as the test or assignment templates can have any suitable format as may be desired for a particular application. The format of the template can be selected using the portable teacher unit 14, either by depressing predefined mode buttons on the unit 14 which are preprogramed to select a given format, or by selecting the template based on information displayed on the LCD display 40. For example, the teacher unit 14 can include a scroll button which allows the user to scroll through menu options on the LCD display 40, and select a template using a selection button.

The portable teacher unit 14 can include any suitable data entry means which allows data to be entered into the Scoring Key template. In one embodiment, alphanumeric data is entered using a pushbutton keypad. The teacher unit 14 can also be configured in another embodiment to provide a touchscreen keypad which is operated by means of a stylus. In yet another embodiment, the portable teacher unit can accept natural human handwriting as data input, with the handwritten entries being entered on the touchscreen by means of a stylus. The handwriting can either be recognized by means of an software resident in the unit 14, or alternatively, saved images can be recognized by the OCR program in the grader unit 12 when the teacher unit 14 is connected thereto.

In the example shown in FIG. 5, the template 50 includes a plurality of answer fields 53. The template also includes a name field 51, which does not form a part of the Scoring Key, but which is optically scanned by the grader unit 12. Using the portable teacher unit 14, the user can select the number of answer fields 53 to be included in the test or assignment. Each field can be assigned a different score value at the time the Scoring Key is created, and the answer fields 53 can be categorized into different sections as shown in the example.

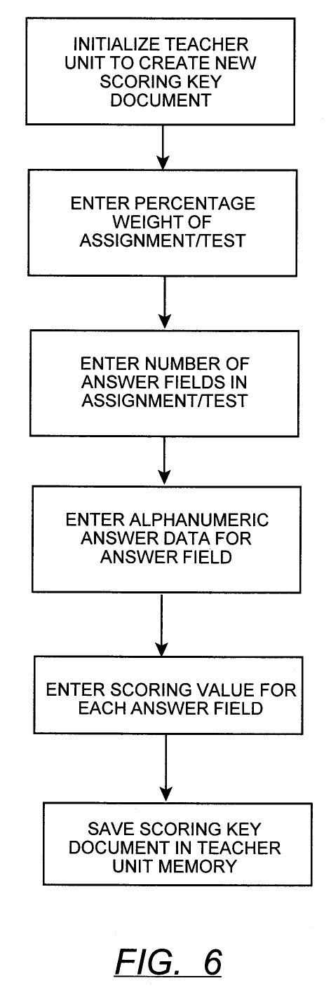

FIG. 6 illustrates the steps for entering the scoring key into the teacher unit. In Step 61 the teacher unit is initialized to create a new scoring key document, usually by entry of a security access code, such as a logon name and/or password. In step 62 the teacher is prompted to enter the percentage weight of the assignment or test. In step 63 the teacher can select the number of answer fields 53 in the assignment or test. The teacher then uses the alphanumeric keypad to enter answer data for each answer field 53. The teacher in step 66 enters the scoring value for each answer field 53. A Scoring Key document file corresponding to the assignment or test is then saved in the memory of the teacher unit 14. In the preferred embodiment, an individual Scoring Key file is created for each new assignment or test.

The test or assignment is administered by providing each the students with a blank test/assignment answer sheet similar to that shown in FIG. 5. The student can then hand-write their name and answer data into the appropriate fields. When the completed tests/assignments are to be graded, the assembled completed test papers can be placed in the sheet feeder 16 of the grader unit 12 in the proper orientation. The respective I/O data ports 27,28 of the portable teacher unit 14 are then coupled, and the desired Scoring Key is downloaded from the teacher unit 14 to the memory 24 of the grader unit 12. The grader unit 12 typically requires a security access code entered from the teacher unit 14, such as logon name and password. Based on the Scoring Key, the optical scanner 20 of the grader unit 12 reads indicia on each individual paper. The optical scanner 20 detects data to be scanned based on the physical location of the designated answer fields on the template page as provided by the Scoring Key.

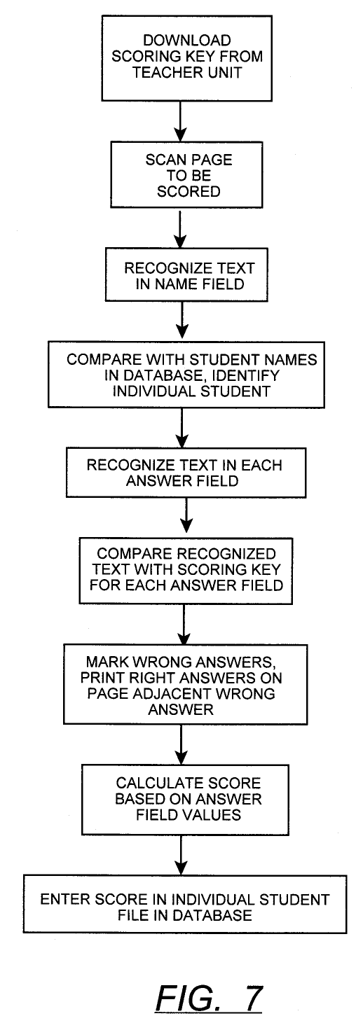

FIG. 7 illustrates the steps for scoring the student documents. A software algorithm is resident in the memory of the grader unit 12 which is includes handwriting OCR capability. The algorithm detects and recognizes indicia in the field specified by the Scoring Key. For each paper to be graded, the OCR software recognizes the handwritten text in the name field. The recognized text from the name field is then compared to student names in a database resident in the memory of the teacher unit 14 so that the individual student to whom the paper belongs can be identified. The indicia in each answer field can then be compared to the Scoring Key for each answer field to determine correct and incorrect answers. In handwritten input is used to compile the Scoring Key, the answer images from the teaching unit 14 are first recognized using the OCR program and then compared to the scanned document. If an incorrect answer is detected, a print command is sent to the printer 18 to print indicia on the paper to indicate an incorrect answer. The printer mechanism in the grader unit is operable to mark the wrong answers, for example with an X, and print the correct answers on the page adjacent to the wrong answer. The grader unit 12 then calculates the score of the paper based on the answer field scoring values. The score is printed on the paper and also entered into the individuals students file in the data base in the teacher unit 14

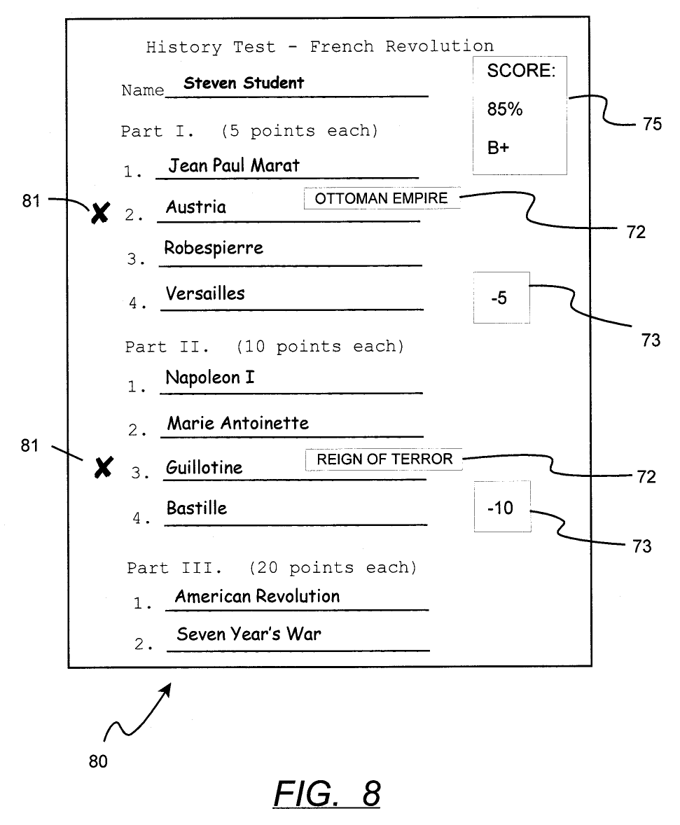

FIG. 8 illustrates an example of a test paper 80 which has been scored by the grader unit 12. Incorrect answers indicated as 81 are marked with an “X.” For each incorrect answer, the correct answer 72 is printed beside the incorrect answer. The point value of each incorrect answer can also be printed, indicated as 73. The overall score 75 is printed on the paper by the grader unit 12. It is preferable that the grader unit 12 print indicia on the paper in an ink color which contrasts with the ink color of the original paper. For example, if the text of the original printed template is in black ink, the grader unit 12 can print scores and other indicia in red ink.

In the preferred embodiment, the ROM 32 or RAM 35 of the portable teacher unit 14 includes a spreadsheet algorithm which provides the platform for the student information database. The spreadsheet algorithm can be any commercially available software program which allows the database in the memory to be manipulated to create the desired spreadsheet. The spreadsheet can then be downloaded to the grader unit and printed in ASCII format. The spreadsheet can be in a format similar to a teacher's grade book, and can include a listing of student names and all student grades for any number of the test and assignments which were administered in a given period. This spreadsheet averages the grades according to the assignment and test percentage weights which have been entered by the teacher.

A key feature of the inventive system is that it allows a teacher to use different grading scales and criteria which may be used depending on the nature of the test or assignment. The software converts the different grading scales to a common numerical grading scale, such as a percentage, so that the scores can be averaged. For example, the scores may be percentages (0-100%), letter grades (A-F), satisfactory/unsatisfactory, and rubric grades. A rubric is a marking system used by many-teachers which scores performances based on various criteria and levels of fulfillment of those criteria. A rubric grade can be a point value, e.g. a score of 1-5. To average the grades, the system converts the rubric score to a percentage score (e.g. a rubric score of 4=percentage 80%), and multiples the percentage score by the assigned percentage weight. The portable teacher's unit 14 also includes a means to input additional outside grades (not obtained through the grader unit 12) into student record files.

The portable teacher unit also includes an I/O data port which allows the portable teacher unit 14 to be coupled to a personal electronic device, such as a personal computer. The I/O data port can be I/O data port 28, or the teacher unit 14 can have at least one additional d5ata port. This provides the capability of downloading complete student data (name, address, photos, etc.) from a personal computer to the portable teacher unit 14. Spreadsheet files can also be uploaded from the teacher unit 14 to a personal computer, for further manipulation or archiving. The system of the invention can also include software which can be installed on a personal computer which allows the personal computer to directly interface with the teacher unit 14. The software can include Scoring Key templates which enable one to prepare the Scoring Key on a personal computer and then download it to the portable teacher unit 14.

The memory 24 of the grader unit 12 can also include standard “spell checker” and “grammar checker” software which is commonly commercially available for word-processing applications. This allows written essay-type tests or assignments to be scored based on spelling and grammar use when the appropriate Scoring Key is downloaded to the grader unit 12.

As shown in FIG. 4, the portable teacher unit 14 can include a plurality of function keys generally indicated as 41. The function keys 41 can be pre-programmed to provide short-cuts to frequently used applications. For example, the function keys 41 can each indicate a different type of test or assignment key to be prepared, e.g. class work, homework, quiz, test, final exam, etc. The function keys 41 can be programmed to initialize the appropriate Scoring Key template for the type of test or assignment, and automatically assign the appropriate percentage weight to the test or assignment for averaging a final grade.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

1. (canceled)

2. The system of claim 21, where said at least one portable teacher unit comprises a plurality of portable teacher units.

3. The system of claim 21, wherein said grader unit has a housing configured to provide a docking station therein containing said data I/O port of said grader unit, and said portable teacher unit has a housing configured for complementary mated engagement with said docking station wherein said data I/O port of said portable teacher unit aligns and engages with said data I/O port of said grader unit.

4. The system of claim 3, wherein said docking station is configured to accept and secure at least a portion of said portable teacher unit whereby said unit can be accessed and operated by a user while docked.

5. The system of claim 21, wherein said alphanumeric data input means of said teacher unit is a keypad.

6. The system of claim 21, wherein said alphanumeric data input means of said teacher unit is a touchscreen.

7. The system of claim 21, wherein said touchscreen accepts handwritten data using a stylus.

8. The system of claim 7, wherein said memory of said portable teacher unit includes OCR software operable to convert said handwritten data into ASCII characters for storage in said memory.

9. The system of claim 7, wherein images of said handwritten data are transmitted from said teacher unit to said grader unit, and said handwritten data is converted into ASCII characters by said OCR software resident in said grader unit memory.

10. The system of claim 21, wherein said display means of said teacher unit is a LCD display.

11. The system of claim 21, wherein said database resides in said memory of said at least one portable teacher unit, and said memory in said portable teacher unit further includes a spreadsheet algorithm, and said database can be manipulated using said spreadsheet algorithm to generate a desired spreadsheet.

12. The system of claim 11, wherein said spreadsheet can be downloaded to said grader unit and said grader unit is operable to print said spreadsheet in ASCII format.

13. The system of claim 21, wherein said portable teacher unit further comprises a data I/O port which can be coupled to a personal electronic device for bidirectional data transmission.

14. The system of claim 13, wherein said Scoring Key can be downloaded to said portable teacher unit from said personal electronic device.

15. The system of claim 21, wherein I/O ports are IR ports, and said means for coupling said grader unit to said teacher unit is IR data transmission.

16. The system of claim 21, wherein I/O ports are RF antennas, and said means for coupling said grader unit to said teacher unit is RF data transmission.

17. The system of claim 21, wherein said memory of said grader unit includes spell-checking software.

18. The system of claim 21, wherein said memory of said grader unit includes grammar-checking software.

19. The system of claim 21, wherein data can be transmitted from said portable teacher unit to said grader unit for printing.

20. The system of claim 21, wherein said portable teacher unit is operable to assign a scoring weight to said Scoring Key.

21. A school paper grading and progress tracking system for use by a teacher, comprising:
at least one portable teacher unit including a teacher unit processing means, a teacher unit memory, a teacher unit alphanumeric data input means, a teacher unit display means, and at least one teacher unit data I/O port, said teacher unit processing means operable to accept entry of a Scoring Key into said teacher unit memory using said alphanumeric input means of said teacher unit, said Scoring Key containing the correct test answers;
a grader unit including a grader unit processing means, a grader unit memory, a printer means, a scanner unit having Optical Character Recognition (OCR) means wherein said scanner unit is operable to optically recognize indicia on a sheet of paper, a grader unit data I/O port, and a sheet-feeding means configured to receive said sheet of paper and automatically guide said sheet of paper through said scanner unit and said printer means whereby indicia on said sheet of paper can be read and additional indicia printed thereon; said grader unit memory having a software algorithm resident thereon operable to perform the following steps:
recognizing indicia on the sheet of paper representing a student's test answers;
comparing the recognized indicia to said Scoring Key to determine correct and incorrect answers;
sending a print command to said printer to print indicia on the paper to indicate incorrect answers;
determining the number of incorrect answers;
calculating a Score based on the number of incorrect answers;
storing the Score in a database; and
sending a print command to the printer to print indicia on the paper to indicate the Score;
a means for coupling said portable teacher unit to said grader unit to allow bidirectional data transmission therebetween, whereby said Scoring Key is transmitted from said portable teacher unit to said grader unit.
